(19) United States
(12) Patent Application Publication
(10) Pub. No.: US 2024/0112658 A1
(43) Pub. Date: Apr. 4, 2024

(54) KEYBOARD DEVICE FOR KEYBOARD INSTRUMENT

(71) Applicant: KABUSHIKI KAISHA KAWAI GAKKI SEISAKUSHO, Hamamatsu-shi (JP)

(72) Inventor: Satoshi KITO, Hamamatsu-shi (JP)

(21) Appl. No.: 18/473,973

(22) Filed: Sep. 25, 2023

(30) Foreign Application Priority Data
Sep. 30, 2022 (JP) 2022-157251

(51) Int. Cl. G10H 1/34

(52) U.S. Cl. CPC G10H 1/346; G10H 2220/221; G10H 2220/265

(57) ABSTRACT

A keyboard device for a keyboard instrument, which is capable of obtaining stable let-off feeling from across the whole keyboard device. A let-off member is removably mounted on each of adjacent two of ribs of a keyboard chassis. On a first arm disposed between the two ribs, there are provided a first engagement portion that is temporarily engaged with an engagement protrusion of one of the two let-off members mounted on the adjacent two ribs upon depression of a key to thereby add let-off feeling to touch feeling of the key having been depressed, and a second engagement portion that is engaged with a guide portion of the other let-off member such that the second engagement portion is brought into sliding contact with the guide portion, thereby being guided in a vertical direction.

### BACKGROUND OF THE INVENTION

### Field of the Invention

The present invention relates to a keyboard device which is applied to a keyboard instrument, such as an electronic piano, and has a let-off function of imparting let-off feeling analogous to let-off of an acoustic piano.

### Description of the Related Art

Conventionally, as this type of a keyboard device, there has been known, for example, one disclosed in Japanese Laid-Open Patent Publication (Kokai) No. 2011-27854 already filed by the present applicant. This keyboard device is comprised of a keyboard chassis, keys which extend in a front-rear direction and have rear ends pivotally supported by the keyboard chassis, and hammers provided below the keys for each pivotally moving in interlock with a key associated therewith. The hammers are each pivotally supported on a hammer support shaft provided in the keyboard chassis. When a key is depressed, a predetermined portion of a hammer associated therewith forward of the hammer support shaft is depressed by the key, whereby a portion the hammer rearward of the hammer support shaft is moved upward. Further, at a predetermined portion of the hammer rearward of the hammer support shaft, there is provided an engagement protrusion protruding upward, whereas at a flat plate of the keyboard chassis located between the key and the hammer, there is provided a let-off member made of an elastic material and protruding obliquely downward and forward.

When the key is depressed, the hammer is pivotally moved according to depression of the key, causing the engagement protrusion to move upward, the engagement protrusion of the hammer is temporarily engaged with the let-off member, whereby temporary resistance force acts on the hammer being pivotally moved. With this, let-off feeling analogous to let-off of an acoustic piano is imparted to touch feeling of the key associated with the hammer.

In the keyboard device, to obtain the let-off feeling, the hammer is provided with the engagement protrusion, whereas, since the let-off member is provided between the hammer and the key, a relatively large space is required between the hammer and the key, which increases the height dimension of the keyboard device. Further, since the let-off member is a relatively small component, and what is more, it is mounted between the key and the hammer, when performing assembly or maintenance of the keyboard device, the work for mounting the let-off member on the keyboard chassis or replacing the let-off member with a new one is troublesome and takes much time and labor.

Further, in the keyboard device, let-off feeling sometimes varies from one key to another due to manufacturing error or assembly error of the engagement protrusion provided on the hammer and the let-off member provided on the flat plate of the keyboard chassis. In this case, it is impossible to obtain a stable let-off feeling from across the whole keyboard device. Therefore, there is room for improvement of the keyboard device described above.

### SUMMARY OF THE INVENTION

It is an object of the present invention to provide a keyboard device for a keyboard instrument, which can be constructed compact in size, and for which work for mounting or replacing let-off members can be performed with ease, and further which can give a stable let-off feeling from across the whole keyboard device.

To attain the above object, the present invention provides a keyboard device for a keyboard instrument, which has a let-off function of imparting let-off feeling analogous to let-off of an acoustic piano, including a keyboard chassis having a plurality of partition walls each extending in a front-rear direction and arranged side by side in a left-right direction with a predetermined spacing therebetween, a plurality of keys each extending in the front-rear direction and pivotally arranged on the keyboard chassis at respective associated locations between each adjacent ones of the partition walls, and a plurality of hammers each extending in the front-rear direction and arranged below an associated one of the keys between each adjacent ones of the partition walls, for each being pivotally moved during key depression in interlock with the associated key, wherein a let-off member and a guide member are removably mounted on each of adjacent two of the partition walls, and wherein one of each hammer disposed between the two partition walls and the key associated with the hammer is provided with a first engagement portion that is temporarily engaged with the let-off member upon depression of the key to thereby add let-off feeling to touch feeling of the key having been depressed, and a second engagement portion that is engaged with the guide member such that the second engagement portion is brought into sliding contact with the guide member, thereby being guided in a vertical direction.

According to this construction, the keyboard chassis has the plurality of partition walls each extending in the front-rear direction and arranged side by side in the left-right direction with the predetermined spacing therebetween, and the plurality of keys are pivotally arranged on the keyboard chassis at the respective associated locations between each adjacent ones of the partition walls. Further, the plurality of hammers are each arranged below the associated one of the keys between each adjacent ones of the partition walls, and each hammer is pivotally moved during key depression in interlock with the associated key. Further, the let-off member and the guide member are removably mounted on each of the adjacent two of the partition walls, and one of each hammer disposed between the two partition walls and the key associated with the hammer is provided with the first engagement portion and the second engagement portion capable of being engaged with the let-off member and the guide member, respectively. When the hammer is pivotally moved in accordance with depression of the key, the first engagement portion is temporarily engaged with the let-off member while the second engagement portion is brought into sliding contact with the guide member, whereby rotational resistance acts on the hammer or the key being pivotally moved. With this, the touch weight of the key is temporarily increased, whereby let-off feeling analogous to that of the acoustic piano is added to the touch feeling of the key.

Since the let-off member is provided on a partition wall disposed lateral to the hammer, differently from the conventional keyboard device which has a let-off member provided above the hammer, it is not required to secure a large space between the hammer and the key. With this, the keyboard device itself, which has the above-described let-off function, can be made compact. Further, since the let-off members are removably mounted on the partition walls, it is possible to easily perform work for mounting or replacing the let-off members during assembly or maintenance of the keyboard device. Further, when the first engagement portion provided on one of the hammer and the key is engaged with the let-off member, the second engagement portion is guided in the vertical direction while being in sliding contact with the guide member, so that it is possible to achieve stable engagement between the first engagement portion and the let-off member, and consequently it is possible to obtain stable let-off feeling from across the whole keyboard device.

Preferably, the first engagement portion and the second engagement portion are provided on each of the plurality of hammers, and the guide member includes a guide surface with which the second engagement portion of the hammer is brought into vertical sliding contact during pivotal movement of the hammer caused by depression of the key.

According to the construction of this preferred embodiment, the first engagement portion and the second engagement portion are provided on each of the plurality of hammers, and during pivotal movement of the hammer caused by depression of the key, the second engagement portion of the hammer is brought into vertical sliding contact with the guide surface of the guide member. Thus, by guiding the second engagement portion of the hammer in the vertical direction by the guide surface of the guide member, it is possible to cause the first engagement portion of the hammer to be stably engaged with the let-off member.

More preferably, a corner of the guide member formed by a bottom surface and the guide surface thereof has a chamfered shape.

According to the construction of this preferred embodiment, since the corner of the guide member, which is formed by the bottom surface and the guide surface thereof, has the chamfered shape, when the second engagement portion is engaged with the guide member, the second engagement portion can be prevented from being caught on the bottom surface of the guide member, whereby it is possible to smoothly guide the second engagement portion to the guide surface, while preventing useless resistance force from acting on the hammer.

Further preferably, the corner has an R-chamfered shape.

According to the construction of this preferred embodiment, since the corner formed by the bottom surface and the guide surface of the guide member has the R-chamfered shape, when the second engagement portion is engaged with the guide member, it is possible to more smoothly guide the second engagement portion to the guide surface.

Preferably, the keyboard device includes a plurality of guide-provided let-off parts each of which integrally includes a let-off portion having the same function as that of the let-off member and a guide portion having the same function as that of the guide member, the guide-provided let-off parts being made of an elastic material, and the let-off member and the guide member are formed by the guide-provided let-off part.

According to the construction of this preferred embodiment, by forming the guide-provided let-off parts each of which is made of the elastic material and integrally includes the let-off portion and the guide portion, it is possible, compared with a case where the let-off member and the guide member are formed separately from each other, to easily perform work for handling and mounting or removing the guide-provided let-off parts on the keyboard chassis.

The above and other objects, features, and advantages of the present invention will become more apparent from the following detailed description taken in conjunction with the accompanying drawings.

### BRIEF DESCRIPTION OF THE DRAWINGS

FIGS. 1A and 1B are perspective views of a part (one octave section) of a keyboard device for an electronic piano to which the present invention is applied, in which FIG. 1A shows the appearance of the keyboard device and FIG. 1B shows a state in which keys other than a white key and a black key at a left end of the keyboard device are omitted;

FIG. 2 is a perspective view of the keyboard device shown in FIG. 1B in a state in which the white key and the black key are removed, together with respective key support mechanisms therefor, from a keyboard chassis;

FIG. 3A is a plan view of the keyboard device shown in FIG. 1B and FIG. 3B is a cross-sectional view taken along line A-A of FIG. 3A;

FIGS. 4A and 4B are perspective views of the white key and the key support mechanism therefor, in which FIG. 4A shows the white key and the key support mechanism in a connected state and FIG. 4B shows the white key and the key support mechanism in an exploded state;

FIGS. 5A and 5B are perspective views of the black key and the key support mechanism therefor, in which FIG. 5A shows the black key and the key support mechanism in a connected state and FIG. 5B shows the black key and the key support mechanism in an exploded state;

FIGS. 6A and 6B are views useful in explaining operation of the white key in the keyboard device, in which FIG. 6A shows a key-released state and FIG. 6B shows a key-depressed state;

FIGS. 7A and 7B are views useful in explaining operation of the black key in the keyboard device, in which FIG. 7A shows a key-released state and FIG. 7B shows a key-depressed state;

FIGS. 8A and 8B are diagrams useful in explaining an essential part of the present invention, in which FIG. 8A is a plan view of a chassis body of the keyboard chassis in which a let-off part is mounted on every rib, and FIG. 8B is a cross-sectional view taken along line B-B in FIG. 8A;

FIG. 9 is a perspective view of the chassis body, as viewed obliquely from below, with a plurality of let-off parts in the center, in a state in which two let-off parts on the left side are removed from associated ones of the ribs;

FIGS. 10A and 10B are perspective views of a let-off part for a scale A, as viewed obliquely from above and obliquely from below, respectively, and FIGS. 10C and 10D are perspective views of a let-off part for a scale A*, as viewed obliquely from above and obliquely from below, respectively;

FIG. 11A is a front view of a let-off part, FIG. 11B is a right side view of the let-off part shown in FIG. 11A, FIG. 11C is a front view of the let-off part mounted on an associated one of the ribs, and FIG. 11D is a right side view of the let-off part shown in FIG. 11C;

FIG. 12A is a perspective view of a first arm, FIG. 12B is a left side view of the first arm and a let-off part in the key released state, FIG. 12C is a view showing a state immediately after an engagement lug of the first arm being pivotally moved in accordance with key depression is brought into contact with an engagement protrusion of the let-off part, and FIG. 12D is a view showing the engagement lug of the first arm shown in FIG. 12C on an enlarged scale;

FIGS. 13A to 13F are views useful in explaining a sequence of operations of a let-off part caused by pivotal movement of a first arm in accordance with key depression;

FIGS. 14A and 14D are views corresponding, respectively, to FIGS. 12A to 12D, which show the first arm and the let-off part in a case where an engagement lug of the first arm is brought into contact with the engagement protrusion of the let-off part in an inclined state, as viewed in side view;

FIGS. 15A and 15C are views useful in explaining a case where engagement lugs of a first arm are brought into contact with the engagement protrusions of the let-off part in the inclined state, as viewed in plan view, in which FIG. 15A is a perspective view of the first arm, FIG. 15B is a plan view showing the engagement lugs of the first arm and the left and right let-off parts on an enlarged scale, and FIG. 15C shows a state in which the left and right let-off parts appearing in FIG. 15B are separated from the first arm; and

FIG. 16 is a diagram showing an example of changes in touch weight relative to key stroke at the time of key depression, in which broken curves indicate changes in a keyboard device including the first arm shown in FIGS. 12A to 12D, and solid lines indicate changes in a keyboard device including the first arm shown in FIGS. 14A to 14D or FIGS. 15A to 15C.

### DETAILED DESCRIPTION OF PREFERRED EMBODIMENTS

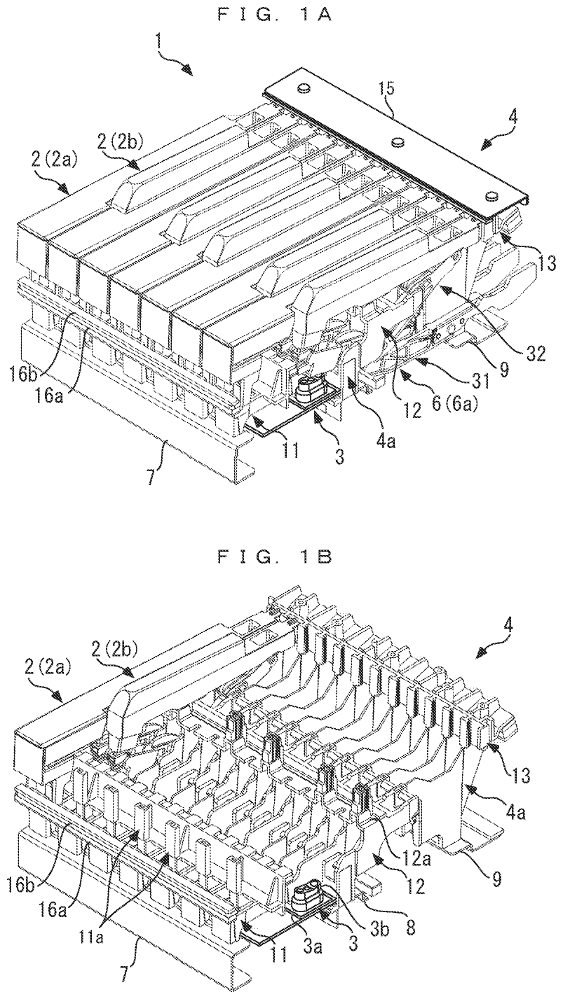

The present invention will now be described in detail with reference to the drawings showing preferred embodiments thereof. FIG. 1A shows only one octave section of a keyboard device 1 for an electronic piano to which the present invention is applied. Note that in the following, a description will be first given of the basic construction of the keyboard device 1 and operation thereof, and then of an essential part of the present invention.

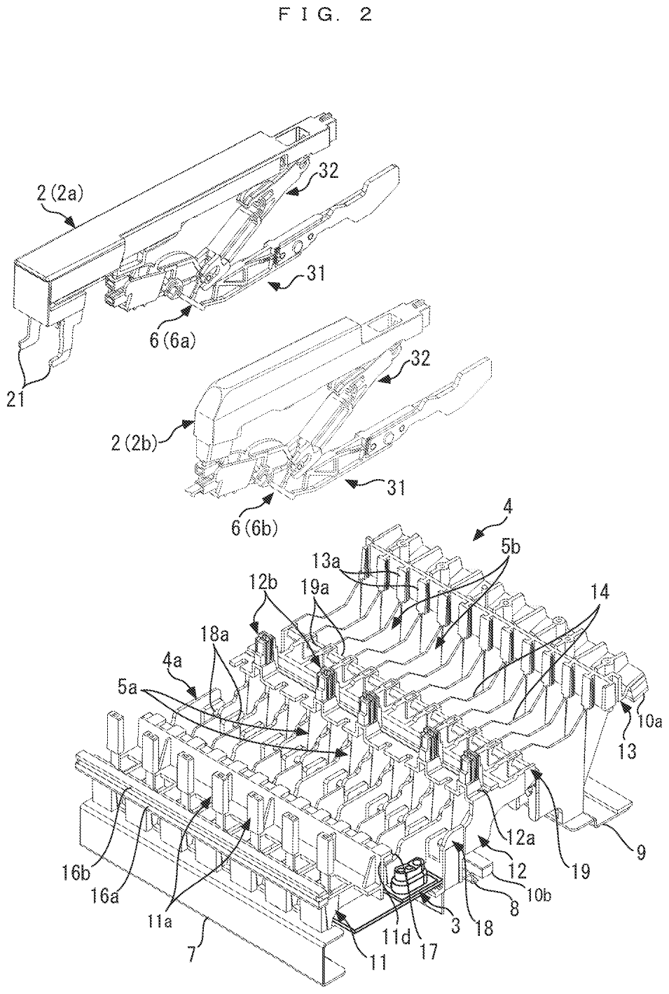

FIG. 1B shows a state of the keyboard device 1 shown in FIG. 1A, in which keys 2 other than a white key 2a and a black key 2b at a left end of the keyboard device 1 are omitted. FIG. 2 shows a state of the keyboard device 1 shown in FIG. 1B, in which the white key 2a and the black key 2b are removed, together with respective key support mechanisms 6 therefor, from a keyboard chassis 4.

This keyboard device 1 is comprised of the keyboard chassis 4, the plurality of keys 2 including the white keys 2a and the black keys 2b and arranged in a state arranged side by side in a left-right direction, the plurality of key support mechanisms 6 each pivotally mounted on the keyboard chassis 4, for supporting an associated one of the keys 2 from below, and key switches 3 each for detecting key depression information of an associated one of the keys 2.

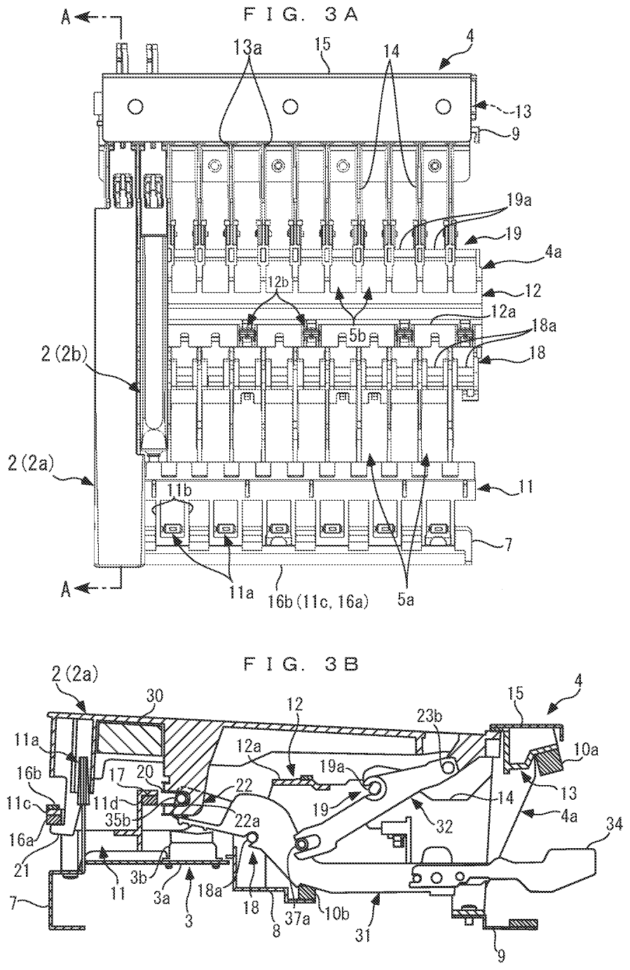

The keyboard chassis 4 includes a chassis body 4a formed as a resin molded article which is made e.g. by injection molding of a predetermined resin material (e.g. an ABS resin) into a predetermined shape. As shown in FIGS. 3A and 3B, the chassis body 4a has a front portion 11, an intermediate portion 12, and a rear portion 13, each extending in the left-right direction (in a left-right direction as viewed in FIG. 3A) as a whole. The front portion 11, the intermediate portion 12, and the rear portion 13 are integrally formed with each other via a plurality of ribs 14 disposed with a spacing therebetween in the left-right direction and each extending in the front-rear direction. Note that in the following description, the front portion 11, the intermediate portion 12, and the rear portion 13 of the chassis body 4a of the keyboard chassis 4 will be referred to as “the chassis front 11”, “the chassis intermediate 12”, and “the chassis rear 13”, respectively.

The chassis front 11 is mainly for guiding the white key 2a during depression thereof and restricting the upper limit position and the lower limit position of a front end of the white key 2a. On the chassis front 11, there are erected a plurality of white key guides 11a, each of which is inserted into each associated one of the white keys 2a from below so as to prevent lateral swing of the white key 2a, in a state arranged side by side in the left-right direction. Further, the chassis front 11 has engagement holes 11b and 11b, vertically extending therethrough, which are formed on the left and right sides of each of the white key guides 11a, respectively. A pair of left and right upper limit position regulation portions 21 and 21, referred to hereinafter, of the white key 2a are engaged with the respective engagement holes 11b and 11b in a state inserted therethrough. Furthermore, the chassis front 11 has a front end thereof formed with a stopper-mounting portion 11c that protrudes forward and extends along the entirety of the chassis body 4a in the left-right direction. A key upper limit stopper 16a and a key lower limit stopper 16b for the white key are mounted on a lower surface and an upper surface of the stopper-mounting portion 11c, respectively, such that they extend in the left-right direction. Note that a stopper-mounting portion 11d for the black key, which extends along the entirety of the chassis body 4a in the left-right direction, is provided at a predetermined location of the chassis front 11, rearward of each white key guide 11a, and that a key upper limit stopper 17 for the black key is mounted on the stopper-mounting portion 11d such that it extends in the left-right direction.

The chassis intermediate 12 is mainly for guiding the black key 2b during depression thereof and swingably supporting a first arm 31 and a second arm 32, described hereinafter, of each of a white key-associated key support mechanism 6a and a black key-associated key support mechanism 6b. The chassis intermediate 12 has a flat portion 12a in the form of a flat plate extending in the left-right direction, and a plurality of black key guides 12b erected on the flat portion 12a and disposed with an appropriate spacing therebetween in the left-right direction. Each black key guide 12b is inserted into an associated one of the black keys 2b from below to prevent lateral swing of the black key 2b. Further, the chassis intermediate 12 has a front portion thereof provided with a first arm support portion 18 for supporting the first arms 31 of the key support mechanisms 6. The first arm support portion 18 has a plurality of first pivot shafts 18a each of which is provided between each adjacent two of the ribs 14 and 14 such that the first pivot shaft 18a extends in the left-right direction. The first arms 31 are swingably supported on associated ones of the first pivot shafts 18a. Furthermore, the chassis intermediate 12 has a rear portion thereof provided with a second arm support portion 19 for supporting the second arms 32 of the key support mechanisms 6. The second arm support portion 19 has a plurality of second pivot shafts 19a each of which is provided between each adjacent two of the ribs 14 and 14 such that the second pivot shaft 19a extends in the left-right direction. The plurality of second pivot shafts 19a are arranged on the same axis extending in the left-right direction at a location rearward of and higher than the first pivot shafts 18a, and the second arms 32 are swingably supported on associated ones of the second pivot shafts 19a. Note that a first arm lower limit stopper 10b extending along the entirety of the chassis body 4a in the left-right direction is provided at a predetermined location of a middle rail 8, referred to hereinafter, disposed below the chassis intermediate 12.

Further, the above-mentioned key switches 3 are provided on a lower portion of the keyboard chassis 4 between the above-described chassis front 11 and chassis intermediate 12. The key switches 3 are formed by a laterally elongated printed circuit board 3a extending in the left-right direction, and a plurality of switch bodies 3b formed by rubber switches attached to the printed circuit board 3a on a key-by-key basis, for being pressed by associated ones of the first arms 31 upon key depression.

The chassis rear 13 is mainly for guiding the keys 2 by their rear ends in the vertical direction while preventing lateral swing of the keys 2 and for restricting the upper limit positions of the rear ends of associated ones of the first arms 31. As shown in FIGS. 2 and 3A, the chassis rear 13 has a plurality of partition walls 13a formed with a predetermined spacing therebetween in the left-right direction so as to separate each adjacent two of the keys 2 and 2 from each other. Further, as shown in FIG. 3B, a first arm upper limit stopper 10a extending along the entirety of the chassis body 4a in the left-right direction is provided at a predetermined location of an upper portion of the chassis rear 13. The first arm upper limit stopper 10a and the above-mentioned first arm lower limit stopper 10b provided on the chassis intermediate 12 are for restricting the upper limit position and the lower limit position of the first arm 31, respectively, when the first arm 31 having a function as a hammer for adding a touch weight to the key 2 pivotally moves upward and downward. Furthermore, a metal cover plate 15 extending in the left-right direction along the entirety of the chassis body 4a and disposed to cover the rear ends of the keys 2 is mounted on the upper portion of the chassis rear 13.

As shown in FIGS. 2 and 3A, the chassis body 4a of the keyboard chassis 4 constructed as described above is formed with a plurality of first openings 5a open upward and forward and a plurality of second openings 5b open upward. The first arms 31 of the key support mechanisms 6 are engaged with associated ones of the first pivot shafts 18a from outside via the above-mentioned first openings 5a, respectively. Further, the second arms 32 are engaged with associated ones of the second pivot shafts 19a from outside via the above-mentioned second openings 5b, respectively.

Further, in the above-described keyboard chassis 4, a plurality of chassis bodies 4a are connected to each other so as to be arranged side by side in the left-right direction, and are each screwed to a front rail 7, the middle rail 8, and a rear rail 9 in a state placed thereon, the rails 7, 8 and 9 each extending in the left-right direction and arranged with a predetermined spacing therebetween in the front-rear direction. The keyboard chassis 4 is fixed to a keybed, not shown, of the electronic piano via the front rail 7 and the rear rail 9.

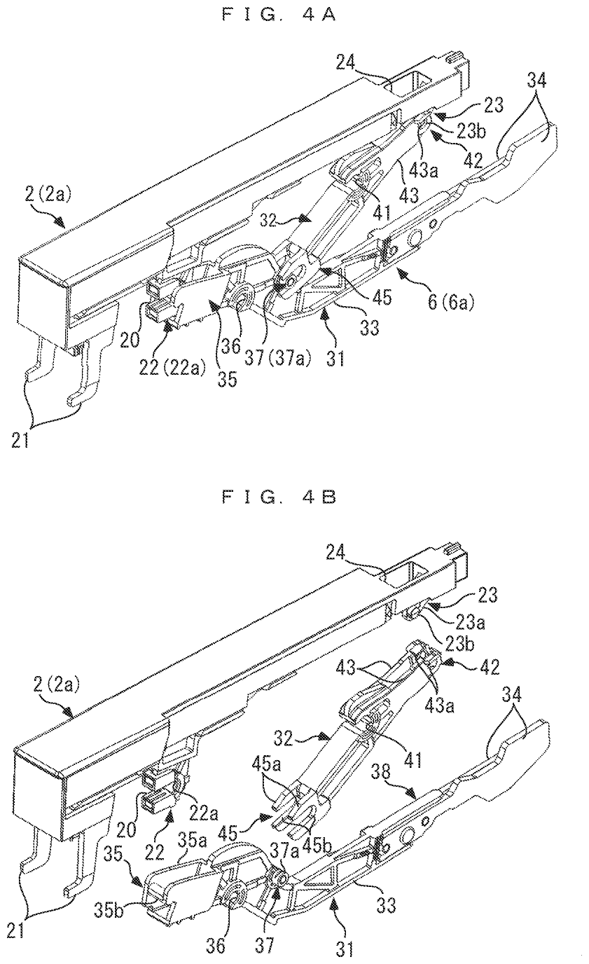

Next, the keys 2 and the key support mechanisms 6 will be described. FIG. 4A shows the white key 2a and the key support mechanism 6a therefor on an enlarged scale, and FIG. 4B shows them in an exploded state. As shown in FIGS. 4A and 4B, the white key 2a is formed e.g. by injection molding of a predetermined resin material (e.g. an AS resin) into a hollow shape which extends a predetermined length in the front-rear direction and opens downward. The white key 2a has the front end thereof formed with the pair of left and right upper limit position regulation portions 21 and 21 which protrude downward from respective side walls of the front end of the white key 2a and each having a lower end thereof bent forward. As described hereinabove, the left and right upper limit position regulation portions 21 and 21 are engaged with the respective left and right engagement holes 11b and 11b of the chassis front 11 in a state inserted therethrough.

Further, at a predetermined location of a front portion of the white key 2a, rearward of the upper limit position regulation portions 21, there is formed a key front-side connecting portion 22 connected to the first arm 31 of the key support mechanism 6a. This key front-side connecting portion 22 includes a connecting recess 22a formed into a U shape having a slot-like shape in side view and open forward. Further, the connecting recess 22a has a cushioning member 20 attached thereto, which is formed to cover the whole inner peripheral surface of the connecting recess 22a, for suppressing generation of noise when a connecting shaft 35b, referred to hereinafter, of the first arm 31 slides in the inner peripheral surface of the connecting recess 22a. Note that in the front portion of the white key 2a, between the above-mentioned upper limit position regulation portions 21 and key front-side connecting portion 22, there is mounted a key weight 30 (see FIG. 3B) for adding a desired touch weight to the white key 2a during depression thereof.

Furthermore, the white key 2a has a rear portion thereof provided with a key rear-side connecting portion 23 connected to the second arm 32 of the key support mechanism 6a. The key rear-side connecting portion 23 has a plate-like connecting body portion 23a which hangs downward from a laterally central portion of the white key 2a and has a predetermined thickness in the left-right direction, and a pair of left and right engagement protrusions 23b and 23b which coaxially protrude from the left and right side surfaces of the connecting body portion 23a, respectively. Further, the rear portion of the white key 2a is formed with a tool insertion hole 24 which vertically extends through the rear portion, and is used to insert a predetermined tool from above for disconnecting the white key 2a from the second arm 32 of the key support mechanism 6a e.g. for maintenance of the keyboard device 1.

On the other hand, the key support mechanism 6a includes the first arm 31 and the second arm 32 which are engaged with each other and are connected to the key front-side connecting portion 22 and the key rear-side connecting portion 23 of the white key 2a, respectively.

As shown in FIG. 4B, the first arm 31 is comprised of an arm body 33 and two weights 34 and 34 attached to the arm body 33. The arm body 33 is formed as a resin molded article which is made e.g. by injection molding of a predetermined resin material (e.g. polyacetal resin) into a predetermined shape. This arm body 33 extends a predetermined length in the front-rear direction, and has a front end thereof formed with a first arm front-side connecting portion 35 connected to the key front-side connecting portion 22 of the white key 2a. The first arm front-side connecting portion 35 includes a box portion 35a having a box-like shape open upward and forward, and the connecting shaft 35b provided such that it extends in the left-right direction in a state connecting the front-side upper ends of left and right side walls of the box portion 35a to each other. The connecting shaft 35b is connected to the connecting recess 22a of the key front-side connecting portion 22 of the white key 2a such that the connecting shaft 35b is pivotally movable and is slidable in the front-rear direction.

Further, the arm body 33 has a bearing portion 36 formed at a predetermined location immediately rearward of the first arm front-side connecting portion 35. The bearing portion 36 has an inverted U shape open downward in side view, and is pivotally engaged with the first pivot shaft 18a of the keyboard chassis 4. Furthermore, the arm body 33 has a first arm rear-side connecting portion 37, which is connected to the second arm 32, at a predetermined location rearward of the bearing portion 36. Specifically, the first arm rear-side connecting portion 37 has a connecting shaft 37a which extends in the left-right direction with respective opposite ends thereof protruding outward from the left and right side surfaces of the arm body 33. The opposite ends of the connecting shaft 37a are engaged with connecting recesses 45b and 45b of a second arm front-side connecting portion 45, referred to hereinafter, of the second arm 32.

The two weights 34 and 34 formed as elongated and narrow plates are mounted on a weight mounting portion 38, which is a rear portion of the arm body 33, in a state sandwiching the weight mounting portion 38. Note that each weight 34 is made of a material (metal such as iron) having a larger specific gravity than the arm body 33, and is formed e.g. by pressing a metal plate into a predetermined shape.

The second arm 32 is formed as a resin molded article having a predetermined shape by injection molding of the same resin material as that of the arm body 33 of the first arm 31. The second arm 32 is shorter than the first arm 31 and extends a predetermined length in the front-rear direction. Further, the second arm 32 has a bearing portion 41 having a C shape open forward in side view approximately at a longitudinal center thereof. The bearing portion 41 is pivotally engaged with an associated one of the second pivot shafts 19a of the keyboard chassis 4.

Further, the second arm 32 has a rear portion thereof provided with a second arm rear-side connecting portion 42 connected to the key rear-side connecting portion 23 of the white key 2a. The second arm rear-side connecting portion 42 is formed into a bifurcated shape, and has two left and right connecting arm portions 43 and 43 which extend a predetermined length parallel to each other along the longitudinal direction of the second arm 32. Each connecting arm portion 43 has a rear end thereof formed with a connecting hole 43a extending through the connecting arm portion 43 in the left-right direction. The two connecting arm portions 43 and 43 sandwich the connecting body portion 23a of the key rear-side connecting portion 23 of the white key 2a between the rear ends thereof from the left and the right, and each connecting hole 43a has an associated one of the engagement protrusions 23b of the key rear-side connecting portion 23 pivotally fitted therein.

Furthermore, the second arm 32 has a front portion thereof provided with the second arm front-side connecting portion 45 connected to the first arm rear-side connecting portion 37 of the first arm 31. The second arm front-side connecting portion 45 has a pair of left and right connecting portions 45a and 45a arranged with a predetermined spacing in the left-right direction. The connecting portions 45a and 45a are each formed with the connecting recess 45b which has a U shape having a slot-like shape in side view and open forward. The left and right connecting portions 45a and 45a of the second arm front-side connecting portion 45 are pivotally and slidably engaged with the respective opposite ends of the connecting shaft 37a of the first arm 31 via the connecting recesses 45b and 45b thereof.

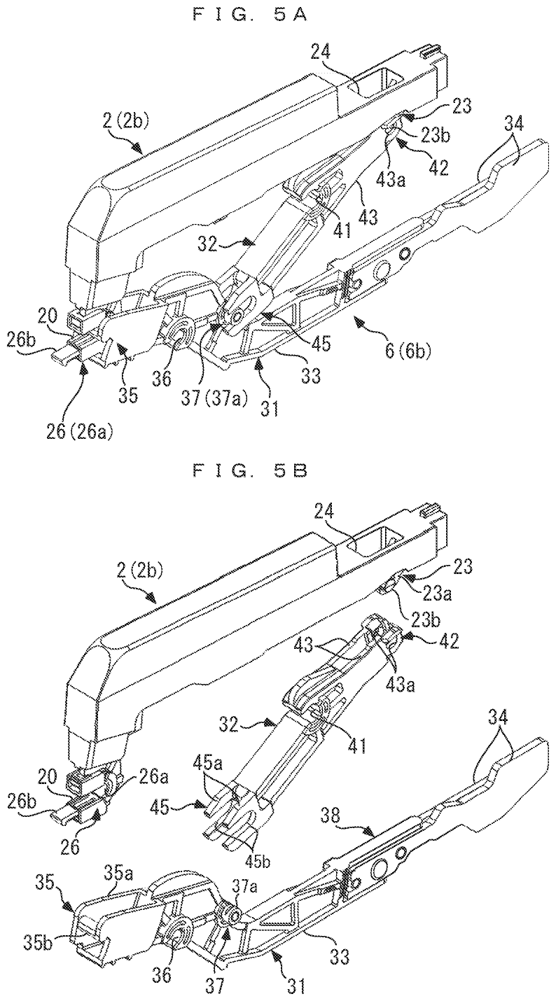

FIG. 5A shows the black key 2b and the key support mechanism 6b therefor on an enlarged scale, and FIG. 5B shows the black key 2b and the key support mechanism 6b in an exploded state. The black key 2b is formed e.g. by injection molding of the same resin material as that of the white key 2a into a hollow shape which extends in the front-rear direction by a predetermined length shorter than that of the white key 2a and opens downward. The black key 2b has a front-side lower end thereof provided with a key front-side connecting portion 26 formed substantially similar to the key front-side connecting portion 22 of the white key 2a. This key front-side connecting portion 26 has a connecting recess 26a formed into a U shape having a slot-like shape in side view and open forward. Further, the key front-side connecting portion 26 has an extension portion 26b on a lower-side front end of the connecting recess 26a. The extension portion 26b extends a predetermined length forward of the front surface of the body of the black key 2b. This extension portion 26b functions as an upper limit position regulation portion of the black key 2b. Note that in the following description, the components of the black key 2b and the key support mechanism 6b having the same configurations as those of the above-described white key 2a and key support mechanism 6a are denoted by the same reference numerals and detailed description thereof will be omitted.

The key support mechanism 6b supporting the black key 2b is constructed substantially similar to the above-described white key-associated key support mechanism 6a. Specifically, the arm body 33 of the first arm 31 of the key support mechanism 6b and the second arm 32 of the same are constructed exactly similar in shape and size to the arm body 33 and the second arm 32 of the white key-associated key support mechanism 6a. Note that although the two left and right weights 34 and 34 of the black key-associated key support mechanism 6b are shown exactly the same as the weights 34 and 34 of the white key-associated key support mechanism 6a, the shapes and sizes of the weights 34 and 34 of the key support mechanisms 6a and 6b are changed as deemed appropriate according to touch weights and the like required for the keys 2.

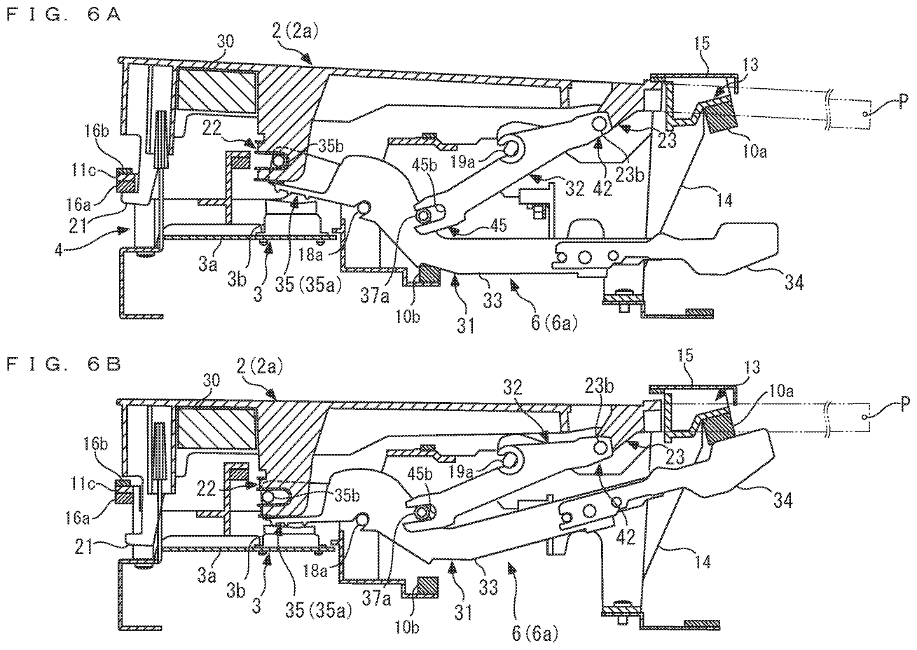

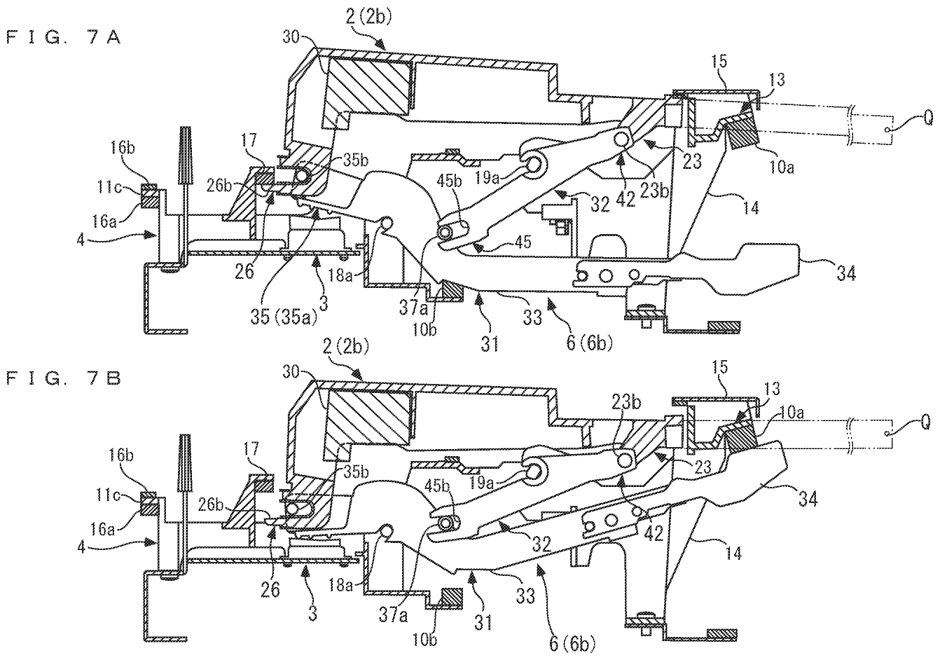

Next, a description will be given of the operation of the keys 2 and the key support mechanisms 6 of the keyboard device 1 constructed as described above. FIGS. 6A and 6B are views useful in explaining the operation of the white key 2a and the key support mechanism 6a associated therewith. FIGS. 7A and 7B are views useful in explaining the operation of the black key 2b and the key support mechanism 6b associated therewith.

When the front end of the white key 2a is depressed by a player with his/her finger from a key-released state shown in FIG. 6A, the key front-side connecting portion 22 of the white key 2a is moved downward, whereby the first arm 31 is pivotally moved in a counterclockwise direction about the first pivot shaft 18a. Further, in accordance with the pivotal movement of the first arm 31, the second arm front-side connecting portion 45, which is engaged with the connecting shaft 37a of the first arm 31 via the connecting recesses 45b and 45b, is moved upward. With this, the second arm 32 is pivotally moved in a clockwise direction about the second pivot shaft 19a. Then, in accordance with this pivotal movement of the second arm 32, the key rear-side connecting portion 23, which is connected to the second arm 32 via the second arm rear-side connecting portion 42 formed at the rear end of the second arm 32, is pulled down, whereby the rear end of the white key 2a is moved downward.

Note that during the above-mentioned pivotal movement of the first arm 31, the box portion 35a of the first arm front-side connecting portion 35 is moved downward, and accordingly, the switch body 3b of one of the key switches 3, which is associated with the depressed key 2, is pressed from above by the bottom wall of the box portion 35a. As a consequence, in the electronic piano, key depression information of the depressed key 2 is detected, and based on the detected key depression information, sound is generated from a speaker, not shown.

As described hereinabove, in the case where the white key 2a is depressed, in accordance with the counterclockwise pivotal movement of the first arm 31, the weight 34 of the first arm 31 is inclined such that the weight 34 becomes higher as it extends rearward, whereby the rear end of the weight 34 is brought into contact with the first arm upper limit stopper 10a from below, as shown in FIG. 6B. This prevents further pivotal movement of the first arm 31. When the front end of the white key 2a is depressed to its lowest position, the front end of the white key 2a is brought into contact with the key lower limit stopper 16b, which blocks further depression of the white key 2a.

The white key 2a depressed as above operates such that it pivotally moves about a virtual pivot P located rearward of the rear end thereof. The location of the virtual pivot P is set such that a distance from the front end of the white key 2a is approximately twice as long as the length of the white key 2a itself, for example. With this, when the front end of the white key 2a is depressed to the lowest position, compared with the case where the white key 2a is in the key-released state shown in FIG. 6A, the front end of the white key 2a is positioned lower by a predetermined key stroke (e.g. 10 mm) and the rear end of the white key 2a is located lower by a distance (e.g. 5 mm) which is approximately half of the predetermined key stroke.

On the other hand, when the finger is released from the white key 2a having been depressed, the first arm 31 of the key support mechanism 6a pivotally moves in a direction opposite to the above-mentioned direction, by the own weight of the weight 34, and in accordance therewith, the second arm 32 as well pivotally moves in a direction opposite to the above-mentioned direction. In accordance with this pivotal movement of the second arm 32, the white key 2a pivotally moves upward about the virtual pivot P. Then, a predetermined portion of the first arm 31, rearward of the first pivot shaft 18a, moves into contact with the first arm lower limit stopper 10b from above, and both of the upper limit position regulation portions 21 and 21 of the white key 2a move into contact with the key upper limit stopper 16a from below, whereby further pivotal movement of the white key 2a is blocked and the white key 2a returns to its original key-released state.

Further, when the black key 2b is depressed, operations are performed similar to the above-described operations of the white key 2a and the key support mechanism 6a. More specifically, when a front end of the black key 2b is depressed from a key-released state shown in FIG. 7A, the first arm 31 is pivotally moved in the counterclockwise direction about the first pivot shaft 18a, and the second arm 32 is pivotally moved in the clockwise direction about the second pivot shaft 19a. With this, the black key 2b is operated such that it is pivotally moved about a virtual pivot Q located rearward of the rear end thereof. Note that similar to the above-mentioned virtual pivot P of the white key 2a, the location of the virtual pivot Q is set such that a distance from the front end of the black key 2b is approximately twice as long as the length of the black key 2b itself, for example. Therefore, when the front end of the black key 2b is depressed to its lowest position, compared with a case where the black key 2b is in the key-released state shown in FIG. 7A, the front end of the black key 2b is positioned lower by a predetermined key stroke and the rear end thereof is positioned lower by a distance which is approximately half of the predetermined key stroke.

On the other hand, when the finger is released from the black key 2b having been depressed, the first arm 31 and the second arm 32 of the key support mechanism 6b pivotally move in respective directions opposite to the above-mentioned directions, and in accordance therewith, the black key 2b pivotally moves upward about the virtual pivot Q. Then, the extension portion 26b of the key front-side connecting portion 26 of the black key 2b moves into contact with the key upper limit stopper 17 from below, whereby further pivotal movement of the black key 2b is blocked, and the black key 2b returns to its original key-released state.

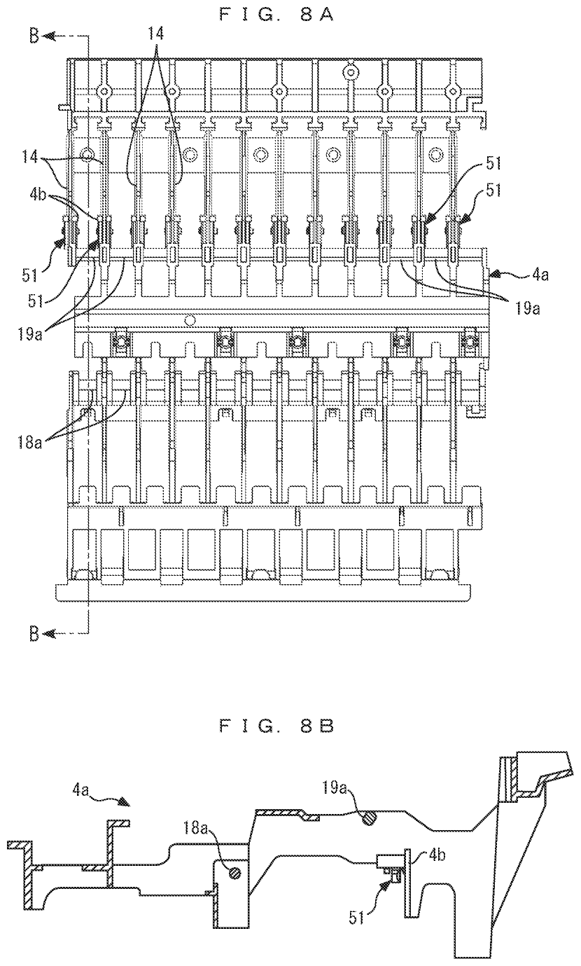

Next, the essential part of the present invention will be described with reference to FIGS. 8A to 16. The essential part of the present invention is a let-off function provided for the keyboard device 1. Specifically, a let-off part is provided on the rib 14 (partition wall) disposed lateral to the first arm 31 (hammer), and an engagement lug that is capable of being engaged with the let-off part is provided on the first arm 31, whereby during pivotal movement of the first arm 31 caused by key depression, the let-off part and the engagement lug are temporarily engaged with each other, to thereby add let-off feeling to the touch feeling of a depressed one of the keys 2.

FIGS. 8A and 8B show states in which let-off parts 51 (guide-provided let-off parts, let-off members, guide members) are mounted on all the plurality of (twelve in FIG. 8A) ribs 14 of the chassis body 4a of the keyboard chassis 4. FIG. 8A is a plan view of the chassis body 4a, and FIG. 8B is a side cross-sectional view taken along line B-B of FIG. 8A. As shown in FIGS. 8A and 8B, each let-off part 51 is mounted on an associated one of the ribs 14 at a predetermined location obliquely downward and rearward of an associated one of the second pivot shafts 19a.

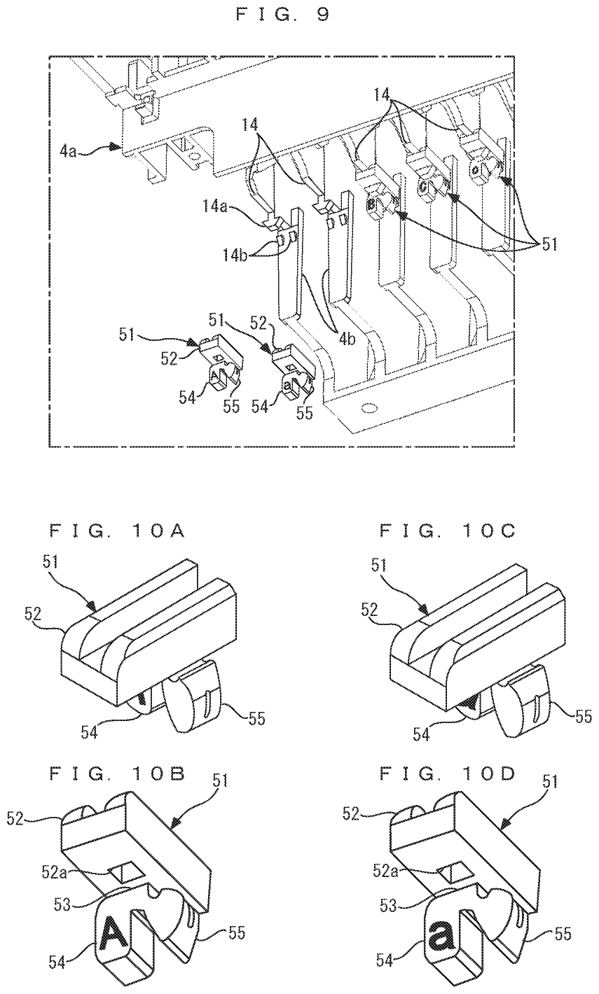

FIG. 9 shows the chassis body 4a, as viewed obliquely from below, with a plurality of let-off parts 51 in the center, in a state in which two let-off parts 51 and 51 on the left side are removed from associated ones of the ribs 14 and 14, respectively. Further, FIGS. 10A and 10B show, out of the two removed let-off parts 51 and 51 appearing in FIG. 9, the left one, as viewed obliquely from above and obliquely from below, respectively, and FIGS. 10C and 10D show the right one, as viewed obliquely from above and obliquely from below, respectively. Note that although, as shown in FIG. 9 and FIGS. 10A to 10D, each let-off part 51 has the same basic construction, a lateral width thereof in the left-right direction is set according to an associated rib 14 on which the let-off part 51 is to be mounted, and hence each let-off part 51 is labeled with a symbol (“A” for scale A in FIGS. 10A and 10B and “a” for scale A# in FIGS. 10C and 10D)) corresponding to respective ribs 14 on which the associated let-off parts 51 are to be mounted.

The let-off part 51 is formed as a molded article which is made of an elastic material (e.g. thermoplastic elastomer) and formed into a predetermined shape. As shown in FIGS. 10A to 10D, the let-off part 51 includes a mounting portion 52 extending a predetermined length in the front-rear direction and formed in a recessed shape open upward, a block-like base portion 53 provided on a rear half of a bottom surface of the mounting portion 52, a guide portion 54 protruding downward from a substantially left half of the base portion 53, and an engagement protrusion 55 (let-off member) protruding downward from a right end of the base portion 53 and toward an opposite side to the guide portion 54.

FIGS. 11A and 11B are a front view and a right side view of the let-off part 51, respectively. As shown in FIGS. 11A to 11D and FIGS. 10A to 10D, in the mounting portion 52 of the let-off part 51, there is formed a mounting hole 52a vertically extending therethrough at a location immediately forward of the base portion 53. Further, the guide portion 54 on the left side of the let-off part 51 includes a guide surface 54a extending flat in the vertical direction. In addition, a corner 54b formed by a bottom surface of the guide portion 54 and the guide surface 54a thereof has an R-chamfered shape.

On the other hand, the right engagement protrusion 55 has a predetermined shape in front view, as shown in FIG. 11A, and includes a bent surface 55a bent convex outward. Note that this bent surface 55a is formed with a groove 55b extending in the vertical direction so as to store lubricant, such as grease, for being applied to the engagement protrusion 55.

Further, the let-off part 51 has a neck part 53a formed between the base portion 53 and the engagement protrusion 55. With this, the engagement protrusion 55 is easy to bend toward the guide portion 54.

Further, as shown in FIG. 9, at predetermined locations of each rib 14 on which an associated one of the let-off parts 51 is mounted, a coming-off prevention portion 14a and two left and right engagement lugs 14b and 14b for securely attaching each let-off part 51 to the rib 14 are integrally formed on the chassis body 4a, respectively. The coming-off prevention portion 14a protrudes a predetermined length downward from a lower surface of the rib 14, and has a lower end formed with an increased-width portion which has a larger width than a portion of the coming-off prevention portion 14a upward of the lower end and is formed into a shape tapered downward. On the other hand, each engagement lug 14b is provided rearward of the coming-off prevention portion 14a such that an upper surface thereof protrudes forward at the same height level as that of an upper end of the increased-width portion of the coming-off prevention portion 14a.

FIGS. 11C and 11D show a state in which the let-off part 51 has been mounted on the rib 14 via the coming-off prevention portion 14a and the engagement lugs 14b. As shown in FIGS. 11C and 11D, in the state in which the let-off part 51 has been mounted on the rib 14, the mounting portion 52 of the let-off part 51 sandwiches the rib 14 from the left and the right, and the increased-width portion formed on the lower end of the coming-off prevention portion 14a of the rib 14 extends through the mounting hole 52a of the mounting portion 52 from above. Further, the left and right engagement lugs 14b and 14b rearward of the coming-off prevention portion 14a is engaged with a rear end of a lower surface of the mounting portion 52 from below. As described above, each let-off part 51 is firmly mounted on the lower end of the associated one of the ribs 14 at a predetermined location.

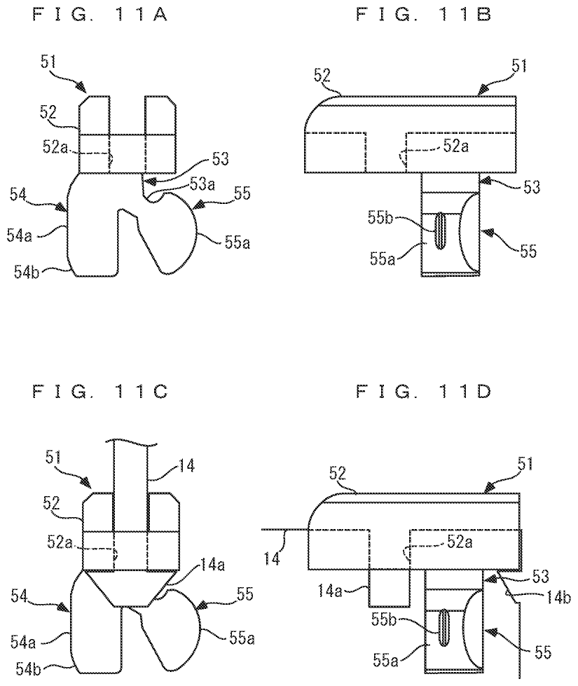

FIGS. 12A to 12D show the first arm 31. FIG. 12A is a perspective view of the first arm 31, and FIG. 12B is a left side view of the first arm 31 in the key-released state. As shown in FIGS. 12A and 12B, the first arm 31 is provided with two left and right engagement lugs 39 and 39 (first engagement portion and second engagement portion) which are temporarily engaged with the left and right let-off parts 51 and 51 during pivotal movement of the first arm 31 caused by key depression. The two engagement lugs 39 and 39 are symmetrically provided at respective upper portions of the left and right sides of the first arm 31, more specifically, at predetermined locations rearward (leftward in FIGS. 12A to 12D) of the bearing portion 36 and the connecting shaft 37a and immediately forward of the weight mounting portion 38. Further, each engagement lug 39 is provided on a lateral rib 33a formed to protrude from a side surface of the arm body 33 and extend in the front-rear direction, such that the engagement lug 39 extends a predetermined length along the lateral rib 33a and slightly protrudes laterally from the lateral rib 33a. Note that, similar to the lateral rib 33a, in the key-released state, as shown in FIG. 12B, the above-described engagement lug 39 is inclined downward toward the rear.

Note that there are provided vertically extending guide protrusions 40 and 40 immediately rearward of the two engagement lugs 39 and 39. The guide protrusions 40 and 40 are opposed to arm guides 4b (see FIGS. 8A, 8B and 9) of the chassis body 4a in a state close thereto, whereby when the first arm 31 pivotally moves, lateral swing of the first arm 31 is prevented.

Further, as shown in FIGS. 12C and 12D, each of the above-described engagement lugs 39 is formed such that when the engagement lug 39 starts to be engaged with the engagement protrusion 55 of an associated one of the let-off parts 51, an edge of the engagement lug 39 toward the engagement protrusion 55 becomes parallel to the engagement protrusion 55, as viewed in side view and plan view.

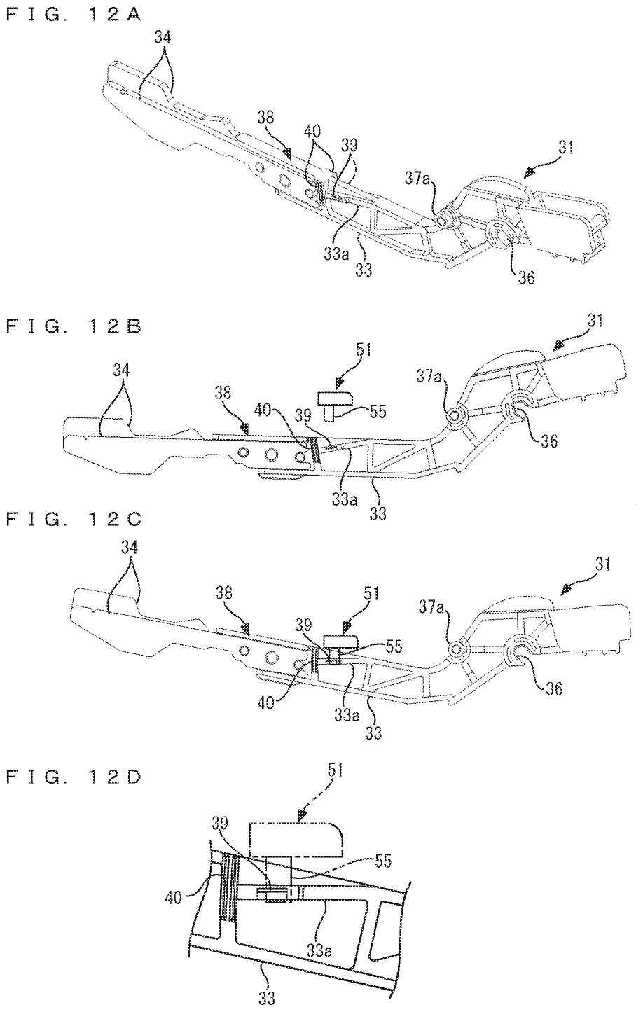

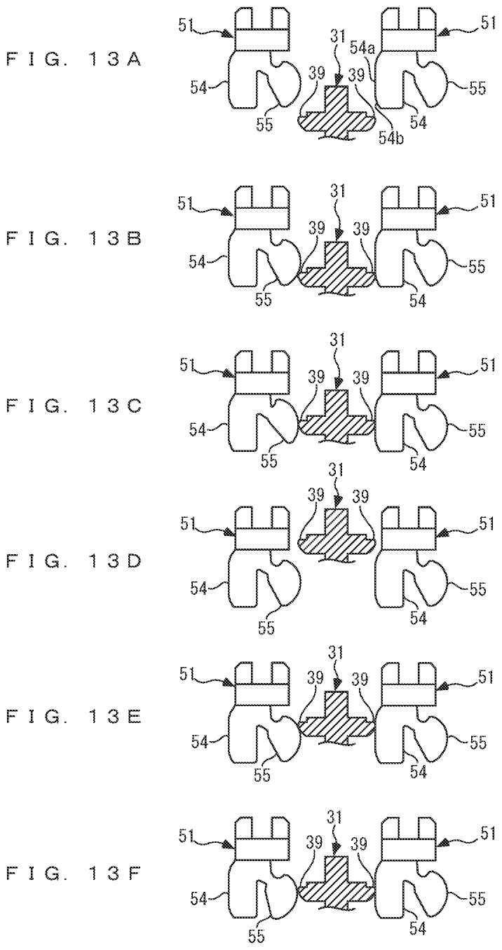

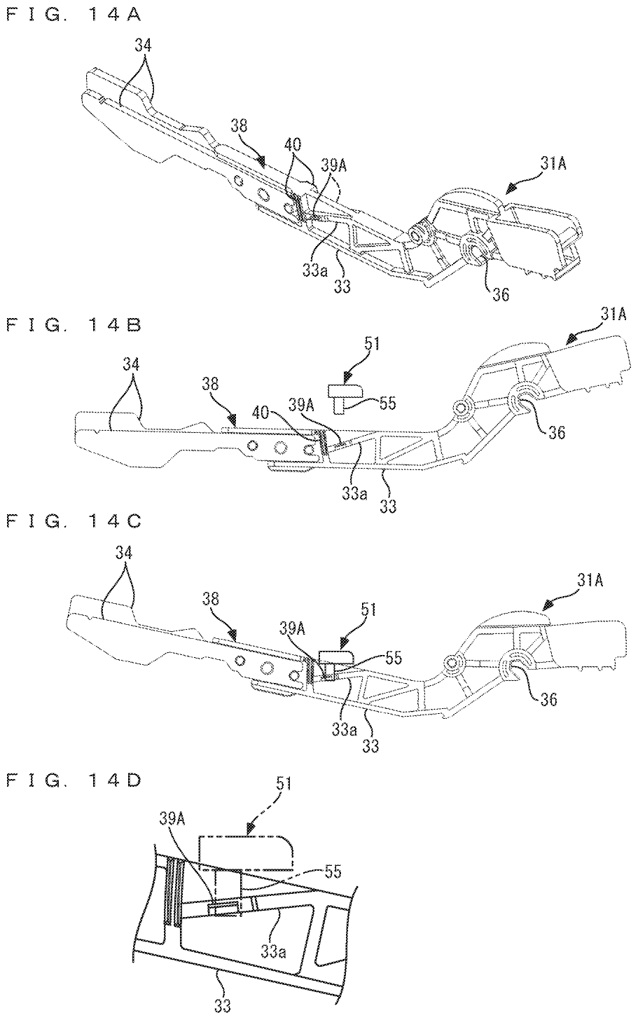

Now, the operation of the let-off part 51 caused by the pivotal movement of the first arm 31 in accordance with key depression will be described with reference to FIGS. 13A to 13F. FIG. 13A shows the left and right engagement lugs 39 and 39 of the first arm 31 in the key-released state and the two left and right let-off parts 51 and 51 mounted on the libs 14 and 14 (not shown in FIGS. 13A to 13F) disposed toward the left and right sides of the first arm 31, respectively.

When one of the keys 2 is depressed, one of the first arms 31, which is associated with the depressed key 2, is pivotally moved in a predetermined direction, and in accordance therewith, the left and right engagement lugs 39 and 39 of the first arm 31 are moved upward and are brought into contact with the right engagement protrusion 55 of the left let-off part 51 and the guide portion 54 on the left side of the right let-off part 51 from below (FIG. 13B). Note that in this case, since the corner 54b of the guide portion 54 toward the first arm 31 has the R-chamfered shape, the engagement lug 39 is smoothly guided to the guide surface 54a without being caught on the bottom surface of the guide portion 54. Then, when the key 2 is further depressed, the first arm 31 as well is further pivotally moved, whereby the right engagement lug 39 (second engagement portion) is guided upward while being held in sliding contact with the guide portion 54 of the right let-off part 51. On the other hand, the left engagement lug 39 (first engagement portion) is moved upward while laterally pushing outward the engagement protrusion 55 of the left let-off part 51 (FIG. 13C), and reaches a position higher than the guide portion 54 and the engagement protrusion 55 (FIG. 13D).

As described above, in the case where the left engagement lug 39 of the first arm 31 being pivotally moved passes the engagement protrusion 55 of the left let-off part 51 upward from below, a reaction force from the engagement protrusion 55 acts on the engagement lug 39, whereby rotational resistance acts on the first arm 31. Further, in this case, since the right engagement lug 39 of the first arm 31 is guided upward while being held in sliding contact with the guide portion 54 of the right let-off part 51, stable engagement between the left engagement lug 39 and the engagement protrusion 55 can be achieved. With this, let-off feeling is added to the touch feeling of the key 2 associated with the first arm 31, that is, the key 2 supported by the key support mechanism 6 including the first arm 31.

Then, when the depression of the key 2 is released, the key 2 pivotally moves upward, and the first arm 31 pivotally moves in a direction opposite to the above-mentioned direction. In accordance therewith, the left and right engagement lugs 39 and 39 of the first arm 31 move downward into contact with the engagement protrusion 55 of the left let-off part 51 and the guide portion 54 of the right let-off part 51 from above (FIG. 13E). Then, when the key 2 further pivotally moves upward, the first arm 31 as well further pivotally moves, and the right engagement lug 39 is guided downward while being held in sliding contact with the guide portion 54 of the right let-off part 51. On the other hand, the left engagement lug 39 moves downward while laterally pushing outward the engagement protrusion 55 of the left let-off part 51 (FIG. 13F), and returns to the above-mentioned key-released state (FIG. 13A).

As described hereinabove, in the case where the engagement lugs 39 and 39 of the pivotally moving first arm 31 pass between the engagement protrusion 55 of the left let-off part 51 and the guide portion 54 of the right let-off part 51 downward from above, the engagement protrusion 55 of the left let-off part 51 is easy to bend inward due to the structure thereof, and the guide portion 54 of the right let-off part 51 is in sliding contact with the engagement lug 39. Therefore, compared with the above-described case where the engagement lugs 39 and 39 pass between the engagement protrusion 55 of the left let-off part 51 and the guide portion 54 of the right let-off part 51 upward from below, the rotational resistance acting on the first arm 31 is very small. Thus, when the key 2 having been depressed is released, the above-mentioned let-off feeling is not generated.

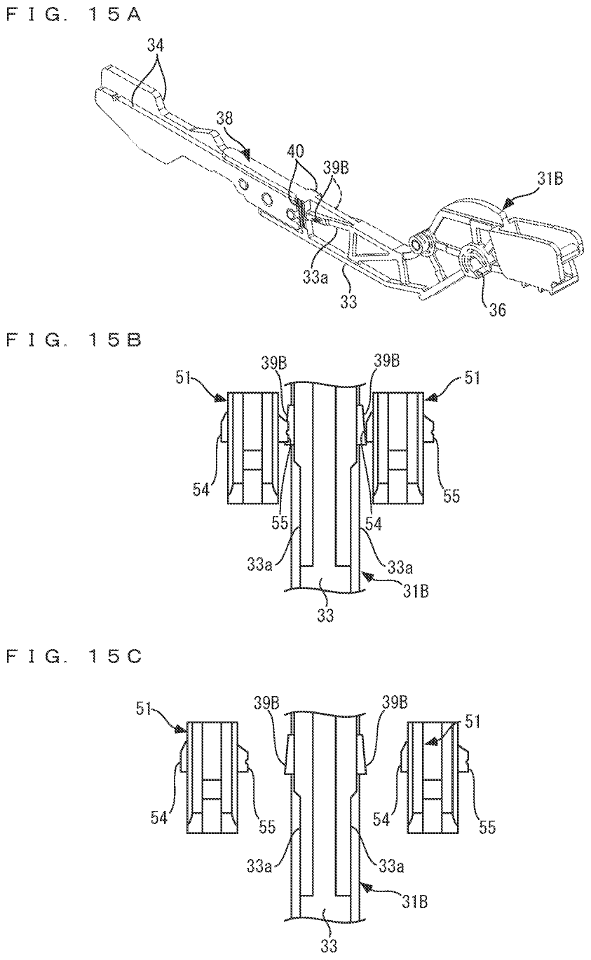

FIGS. 14A to 14D are views corresponding to FIGS. 12A to 12D, respectively, in which in a first arm 31A shown in FIGS. 14A to 14D, the lateral rib 33a of the arm body 33 is more inclined downward toward the rear than in the first arm 31 shown in FIGS. 12A to 12D, whereby left and right engagement lugs 39A and 39A of the arm body 33 are also more inclined downward toward the rear.

FIG. 14C shows a state immediately after one of the engagement lugs 39A of the first arm 31A being pivotally moved in accordance with key depression is brought into contact with the engagement protrusion 55 of the let-off part 51, and FIG. 14D shows the engagement lug 39A of the first arm 31A shown in FIG. 14C and component parts therearound on an enlarged scale. As shown in FIGS. 14C and 14D, each engagement lug 39A of this first arm 31A is formed such that when the engagement lug 39A starts to be engaged with the engagement protrusion 55 of the let-off part 51, an edge of the engagement lug 39A toward the engagement protrusion 55 is inclined with respect to the engagement protrusion 55, as viewed in side view. With this, upon key depression, when the engagement lug 39A of the first arm 31A is engaged with the engagement protrusion 55 of the let-off part 51, the degree of the engagement is progressively increased from the start of the engagement. As a consequence, the degree of increase in resistance force acting on the first arm 31A changes relatively slowly.

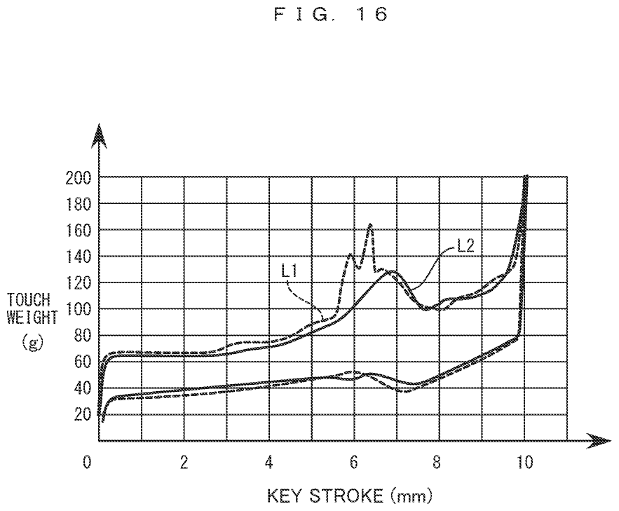

Note that although FIGS. 14A to 14D show the case where the engagement lug 39A of the first arm 31A is formed such that the engagement lug 39A is inclined with respect to the engagement protrusion 55 of the let-off part 51, as viewed in side view, it is also possible to form the engagement lug 39A such that the engagement lug 39A is inclined with respect to the engagement protrusion 55, as viewed in plan view, as shown in FIGS. 15A to 15C.

FIG. 15A shows a first arm 31B, and FIG. 15B is a plan view showing left and right engagement lugs 39B and 39B of the first arm 31B and the left and right let-off parts 51 and 51 which are engaged with the engagement lugs 39B and 39B on an enlarged scale. Note that to make it easy to view the shape of the engagement lugs 39B and 39B, FIG. 15C shows the left and right let-off parts 51 and 51 in a state separated from the first arm 31B.

As shown in FIG. 15C, each engagement lug 39B of the first arm 31B has a front end (lower end in each of FIGS. 15B and 15C) which protrudes more outward from the arm body 33 than a rear end thereof (upper end in each of FIGS. 15B and 15C). That is, each engagement lug 39B of the first arm 31B is formed such that at the start of engagement of the engagement lug 39B with the engagement protrusion 55 of the let-off part 51, an edge of the engagement lug 39B toward the engagement protrusion 55 is inclined with respect to the engagement protrusion 55, as viewed in plan view. With this, upon key depression, when the engagement lug 39B of the first arm 31B is engaged with the engagement protrusion 55 of the let-off part 51, the degree of the engagement is progressively increased from the start of the engagement. As a consequence, the degree of increase in resistance force acting on the first arm 31B changes relatively slowly.

FIG. 16 shows an example of changes in key stroke and touch weight of the key 2 during depression of the key. Further, a first change L1 indicted by a broken curve represents changes in the key stroke and touch weight of the key 2 of the keyboard device 1 including the first arm 31 shown in FIGS. 12A to 12D, and a second change L2 indicted by a solid line represents changes in the key stroke and touch weight of the key 2 of the keyboard device 1 including the first arm 31A shown in FIGS. 14A to 14D or the first arm 31B shown in FIGS. 15A to 15C.

As shown in FIG. 16, in the keyboard device 1 associated with the first change L1, when a front end (key stroke) of the key 2 is depressed by approximately 5.5 mm, the rate of increase in the touch weight is steeply increased, and after being increased by further depression of the key 2, the touch weight is progressively reduced until the front end of the key 2 is depressed by approximately 8 mm. This is because the engagement lug 39 of the first arm 31 shown in FIGS. 12A to 12D is engaged with the engagement protrusion 55 of the let-off part 51, and resistance force from the let-off part 51 is temporarily increased. With this, let-off feeling is added to the touch feeling of the depressed key 2.

On the other hand, in the keyboard device 1 associated with the second change L2, similar to the above, when the front end of the key 2 is depressed by approximately 5.5 mm, the rate of increase in the touch weight is increased but is lower than that of the first change L1. This is because the engagement lug 39A of the first arm 31A shown in FIGS. 14A to 14D and the engagement lug 39B of the first arm 31B shown in FIGS. 15A to 15C are formed to be inclined with respect to the engagement protrusion 55 of the let-off part 51, as viewed in side view and plan view, respectively, whereby the degree of increase in resistance force acting on the first arm 31A and the first arm 31B changes relatively slowly. With this, it is possible to obtain let-off feeling more analogous to that of an acoustic piano.

As described in detail heretofore, according to the present embodiment, when the first arm 31 is pivotally moved in accordance with key depression, one of the engagement lugs 39 is temporarily engaged with the engagement protrusion 55 of the let-off part 51, whereby rotational resistance acts on the first arm 31 being pivotally moved. With this, the touch weight of the key 2 is temporarily increased, whereby it is possible to add let-off feeling analogous to that of the acoustic piano to the touch feeling of the key 2. Further, the above-described let-off parts 51 are disposed on the ribs 14 disposed lateral to the first arm 31, and hence differently from the conventional keyboard device, the keyboard device itself, which has the let-off function, can be made compact. Furthermore, since the let-off parts 51 are removably mounted on the ribs 14, during assembly or maintenance of the keyboard device 1, it is possible to easily perform work for mounting or replacing the let-off parts 51.

Further, in the keyboard device 1 including the first arm 31A or 31B, when each engagement lug 39A of the first arm 31A or each engagement lug 39B of the first arm 31B is brought into contact with the engagement protrusion 55 of the let-off part 51, the degree of the engagement is progressively increased from the start of the engagement, and consequently the degree of increase in resistance force acting on the first arm 31A changes relatively slowly. This makes it possible to obtain let-off feeling more analogous to that of the acoustic piano.

Furthermore, when one of the engagement lugs 39 of the first arm 31 is engaged with the engagement protrusion 55 of an associated one of the let-off parts 51, the other engagement lug 39 is vertically guided while being held in sliding contact with the guide portion 54 of an associated one of the let-off parts 51, so that it is possible to achieve stable engagement between the engagement lug 39 and the engagement protrusion 55 of the let-off part 51 associated therewith. As a result, it is possible to obtain stable let-off feeling from across the whole keyboard device 1.

Note that the present invention is not limited to the above-described embodiment, but it can be practiced in various forms. For example, although in the above-described embodiment, the description is given of a case where the present invention is applied to the keyboard device 1 in which the keys 2 pivotally move about the virtual pivots P and Q located rearward of the rear ends of the keys 2, respectively, the present invention can be applied to a keyboard device which includes keys pivotally moving about rear ends thereof and hammers pivotally moved in interlock with the pivotal movements of the keys.

Further, although in the above-described embodiment, the engagement lugs 39 engaged with the let-off parts 51 are provided on the first arm 31, it is also possible to provide the above engagement lugs on front ends of the keys 2 or the like and provide let-off members for engagement with the engagement lugs on the chassis front 11 of the chassis body 4a as deemed appropriate.

Further, details of the constructions of the first arm 31 and the let-off parts 51 shown in the embodiment are given only by way of example, and they can be modified as appropriate within the scope of the subject matter of the present invention.

It is further understood by those skilled in the art that the foregoing are preferred embodiments of the invention, and that various changes and modifications may be made without departing from the spirit and scope thereof.

What is claimed is:

1. A keyboard device for a keyboard instrument, which has a let-off function of imparting let-off feeling analogous to let-off of an acoustic piano, comprising:
a keyboard chassis having a plurality of partition walls each extending in a front-rear direction and arranged side by side in a left-right direction with a predetermined spacing therebetween;
a plurality of keys each extending in the front-rear direction and pivotally arranged on the keyboard chassis at respective associated locations between each adjacent ones of the partition walls; and
a plurality of hammers each extending in the front-rear direction and arranged below an associated one of the keys between each adjacent ones of the partition walls, for each being pivotally moved during key depression in interlock with the associated key,
wherein a let-off member and a guide member are removably mounted on each of adjacent two of the partition walls, and
wherein one of each hammer disposed between the two partition walls and the key associated with the hammer is provided with a first engagement portion that is temporarily engaged with the let-off member upon depression of the key to thereby add let-off feeling to touch feeling of the key having been depressed, and a second engagement portion that is engaged with the guide member such that the second engagement portion is brought into sliding contact with the guide member, thereby being guided in a vertical direction.

2. The keyboard device according to claim 1, wherein the first engagement portion and the second engagement portion are provided on each of the plurality of hammers, and
wherein the guide member includes a guide surface with which the second engagement portion of the hammer is brought into vertical sliding contact during pivotal movement of the hammer caused by depression of the key.

3. The keyboard device according to claim 2, wherein a corner of the guide member formed by a bottom surface and the guide surface thereof has a chamfered shape.

4. The keyboard device according to claim 3, wherein the corner has an R-chamfered shape.

5. The keyboard device according to claim 1, including a plurality of guide-provided let-off parts each of which integrally includes a let-off portion having the same function as that of the let-off member and a guide portion having the same function as that of the guide member, the guide-provided let-off parts being made of an elastic material, and
wherein the let-off member and the guide member are formed by the guide-provided let-off part.
